(19) United States
(12) Patent Application Publication
(10) Pub. No.: US 2021/0382609 A1
(43) Pub. Date: Dec. 9, 2021

(54) METHOD AND DEVICE FOR DISPLAYING MULTIMEDIA RESOURCE

(71) Applicant: BEIJING DAJIA INTERNET INFORMATION TECHNOLOGY CO., LTD., Beijing (CN)

(72) Inventor: Shuming Ai, Beijing (CN)

(21) Appl. No.: 17/152,376

(22) Filed: Jan. 19, 2021

(30) Foreign Application Priority Data
Jun. 4, 2020 (CN) 202010501422.2

(51) Int. Cl. G06F 3/0484; G10L 25/51; G06K 9/00; G06F 3/0481; G06F 16/48; G06F 16/435; G06N 3/04; G06N 3/08

(52) U.S. Cl. CPC G06F 3/04842; G10L 25/51; G06K 9/00711; G06N 3/08; G06F 16/48; G06F 16/435; G06N 3/04; G06F 3/0481

(57) ABSTRACT

The disclosure relates to a method and device for displaying a multimedia resource, and relates to the field of network technologies. In the disclosure, user attribute of a user account and resource attribute of a multimedia resource are acquired in response to an operation for displaying the multimedia resource being triggered through the user account; a target application function is selected from an associated application function set of the multimedia resource based on the user attribute and the resource attribute of the multimedia resource; and the multimedia resource and a function button of the target application function are displayed in a preset interface area so that the target application function is obtained by selecting and operating the function button through the user account during viewing the multimedia resource.

### CROSS-REFERENCE TO RELATED APPLICATION

This application claims priority to Chinese Patent Application No. 202010501422.2, filed on Jun. 4, 2020, the disclosure of which is hereby incorporated by reference in its entirety.

### TECHNICAL FIELD

The disclosure relates to the field of network technologies, and in particular to a method and device for displaying a multimedia resource.

### BACKGROUND

With popularization of Internet and development of multimedia technologies, it has become a major information source for acquiring information that users need by browsing and viewing, through the Internet, multimedia resources such as short videos.

### SUMMARY

The disclosure provides a method and device for displaying a multimedia resource.

In a first aspect, some implementations of the disclosure provide a method for displaying a multimedia resource, which can be applied to a terminal. The method can include acquiring user attribute of a user account and resource attribute of a multimedia resource in response to an operation for displaying the multimedia resource being triggered through the user account. The method can include selecting a target application function from an associated application function set of the multimedia resource based on the user attribute and the resource attribute of the multimedia resource, where the associated application function set includes one or more application functions associated with the multimedia resource. The method can include displaying the multimedia resource and a function button of the target application function in a preset interface area so that the target application function is obtained by selecting and operating the function button through the user account during viewing the multimedia resource.

In a second aspect, some implementations of the disclosure further provide a method for displaying a multimedia resource, which can be applied to a server. The method can include receiving a target application function acquisition request sent by a terminal, where the target application function request includes user attribute and resource attribute of a multimedia resource, and the target application function acquisition request is generated by the terminal based on the user attribute of a user account and the resource attribute of the multimedia resource after the terminal acquires the user attribute of the user account and the resource attribute of the multimedia resource in response to an operation for displaying the multimedia resource being triggered through the user account. The method can include selecting a target application function from an associated application function set of the multimedia resource and returning it to the terminal according to the target application function acquisition request, so that the terminal displays the multimedia resource and a function button of the target application function in an interface area, and the target application function is obtained by selecting and operating the function button through the user account during viewing the multimedia resource, where the associated application function set includes one or more application functions associated with the multimedia resource.

In a third aspect, some implementations of the disclosure provide a device for displaying a multimedia resource, and the device can be applied to a terminal. The device can include an acquiring module, configured to acquire user attribute of a user account and resource attribute of a multimedia resource in response to an operation for displaying the multimedia resource being triggered through the user account. The device can include a selecting module, configured to select a target application function from an associated application function set of the multimedia resource based on the user attribute and the resource attribute of the multimedia resource, where the associated application function set includes one or more application functions associated with the multimedia resource. The device can include a displaying module, configured to display the multimedia resource and a function button of the target application function in an interface area so that the target application function is obtained by selecting and operating the function button through the user account during viewing the multimedia resource.

In a fourth aspect, some implementations of the disclosure further provide a device for displaying a multimedia resource, which can be applied to a server. The device may include a receiving module, configured to receive target application function acquisition request sent by a terminal, where the target application function request includes user attribute and resource attribute of a multimedia resource, and the target application function acquisition request is generated by the terminal based on the user attribute of a user account and the resource attribute of the multimedia resource after the terminal obtains the user attribute of the user account and the resource attribute of the multimedia resource in response to an operation for displaying the multimedia resource being triggered through the user account. The device can include a processing module, configured to select the target application function from an associated application function set of the multimedia resource according to the target application function acquisition request and returning it to the terminal, so that the terminal displays the multimedia resource and a function button of the target application function in an interface area, and the target application function is obtained by selecting and operating the function button through the user account during viewing the multimedia resource, where the associated application function set includes one or more application functions associated with the multimedia resource.

In a fifth aspect, some implementations of the disclosure further provide a terminal, which may include one or more processors and a memory for storing executable instructions of the processor. The processor is configured to execute the instructions to acquire user attribute of a user account and resource attribute of a multimedia resource in response to an operation for displaying the multimedia resource being triggered through the user account; select a target application function from an associated application function set of the multimedia resource based on the user attribute and the resource attribute of the multimedia resource, where the associated application function set includes one or more application functions associated with the multimedia resource. The processor is configured to execute the instructions to display the multimedia resource and a function button of the target application function in an interface area so that the target application function is obtained by selecting and operating the function button through the user account during viewing the multimedia resource.

In a sixth aspect, some implementations of the disclosure further provide a server, which may include one or more processors and a memory for storing executable instructions of the processor. The processor is configured to execute the instructions to receive a target application function acquisition request sent by a terminal, where the target application function request includes user attribute and resource attribute of a multimedia resource, and the target application function acquisition request is generated by the terminal based on the user attribute of a user account and the resource attribute of the multimedia resource after the terminal obtains the user attribute of the user account and the resource attribute of the multimedia resource in response to an operation for displaying the multimedia resource being triggered through the user account. The processor is configured to execute the instructions to select a target application function from an associated application function set of the multimedia resource according to the target application function acquisition request and returning it to the terminal, so that the terminal displays the multimedia resource and a function button of the target application function in an interface area, and the target application function is obtained by selecting and operating the function button through the user account during viewing the multimedia resource, where the associated application function set includes one or more application functions associated with the multimedia resource.

In a seventh aspect, some implementations of the disclosure further provide a system for displaying a multimedia resource, including a terminal and a server. The terminal and the server are in communication connection. The terminal includes one or more processors and a memory for storing executable instructions of the processor. The processor is configured to execute the instructions to acquire a user attribute of a user account and a resource attribute of a multimedia resource in response to an operation for displaying the multimedia resource being triggered through the user account. The processor is configured to execute the instructions to select a target application function from an associated application function set of the multimedia resource based on the user attribute and the resource attribute of the multimedia resource. The associated application function set includes one or more application functions associated with the multimedia resource; and display the multimedia resource and a function button of the target application function in an interface area, so that the target application function is obtained by selecting and operating the function through the user account during viewing the multimedia resource. The server includes one or more processors and a memory for storing executable instructions of the processor. The processor is configured to execute the instructions to: receive a target application function acquisition request sent by a terminal. The target application function acquisition request includes a user attribute and a resource attribute of a multimedia resource. After acquiring the user attribute of a user account and the resource attribute of the multimedia resource in response to an operation for displaying the multimedia resource being triggered through the user account, the terminal generates the target application function acquisition request based on the user attribute of the user account and the resource attribute of the multimedia resource. The processor is configured to select a target application function from an associated application function set of the multimedia resource in response to the target application function acquisition request, and return the target application function to the terminal, so that the terminal displays the multimedia resource and a function button of the target application function in an interface area, and the target application function is obtained by selecting and operating the function button through the user account during viewing the multimedia resource. The associated application function set includes one or more application functions associated with the multimedia resource.

In an eighth aspect, some implementations of the disclosure also provide a computer-readable storage medium, on which instructions are stored, and the instructions, when executed by a processor, cause the processor to: acquire user attribute of a user account and resource attribute of a multimedia resource in response to an operation for displaying the multimedia resource being triggered through the user account; select a target application function from an associated application function set of the multimedia resource based on the user attribute and the resource attribute of the multimedia resource, where the associated application function set includes one or more application functions associated with the multimedia resource; and display the multimedia resource and a function button of the target application function in an interface area so that the target application function is obtained by selecting and operating the function button through the user account during viewing the multimedia resource.

In a ninth aspect, some implementations of the disclosure also provide a computer-readable storage medium, on which instructions are stored, and the instructions, when executed by a processor, cause the processor to: receive a target application function acquisition request sent by a terminal, in which the target application function request includes user attribute and resource attribute of a multimedia resource, and the target application function acquisition request is generated by the terminal based on the user attribute of a user account and the resource attribute of the multimedia resource after the terminal obtains the user attribute of the user account and the resource attribute of the multimedia resource in response to an operation for displaying the multimedia resource being triggered through the user account; select a target application function from an associated application function set of the multimedia resource according to the target application function acquisition request and returning it to the terminal, so that the terminal displays the multimedia resource and a function button of the target application function in an interface area, and the target application function is obtained by selecting and operating the function button through the user account during viewing the multimedia resource, where the associated application function set includes one or more application functions associated with the multimedia resource.

In a tenth aspect, some implementations of the disclosure provide a computer program product, which, when executed, implements: acquiring user attribute of a user account and resource attribute of a multimedia resource in response to an operation for displaying the multimedia resource being triggered through the user account; selecting a target application function from an associated application function set of the multimedia resource based on the user attribute and the resource attribute of the multimedia resource, where the associated application function set includes one or more application functions associated with the multimedia resource; and displaying the multimedia resource and a function button of the target application function in an interface area so that the target application function is obtained by selecting and operating the function button through the user account during viewing the multimedia resource.

In an eleventh aspect, some implementations of the disclosure provide a computer program product, which, when executed, implements: receiving a target application function acquisition request sent by a terminal, in which the target application function request includes user attribute and resource attribute of a multimedia resource, and the target application function acquisition request is generated by the terminal based on the user attribute of a user account and the resource attribute of the multimedia resource after the terminal obtains the user attribute of the user account and the resource attribute of the multimedia resource in response to an operation for displaying the multimedia resource being triggered through the user account; selecting a target application function from an associated application function set of the multimedia resource according to the target application function acquisition request and returning it to the terminal, so that the terminal displays the multimedia resource and a function button of the target application function in an interface area, and the target application function is obtained by selecting and operating the function button through the user account during viewing the multimedia resource. The associated application function set includes one or more application functions associated with the multimedia resource.

It should be noted that the above general description and the following detailed description are merely example and explanatory and should not be construed as limiting of the disclosure.

### BRIEF DESCRIPTION OF THE DRAWINGS

The accompanying drawings, which are incorporated in the specification and constitute a part of the specification, show example implementations of the disclosure. The drawings along with the specification explain the principles of the disclosure without limiting the disclosure.

FIG. 1 is a schematic diagram of an application scenario provided by an implementation of the disclosure;

FIG. 2 shows a schematic flowchart of a method for displaying a multimedia resource provided by an implementation of the disclosure;

FIG. 3 shows another schematic flowchart of a method for displaying a multimedia resource provided by an implementation of the disclosure;

FIG. 4 shows a schematic flowchart of obtaining a user's interest point tag provided by an implementation of the disclosure;

FIG. 5 shows a schematic diagram of a display interface provided by an implementation of the disclosure;

FIG. 6 shows another schematic flowchart of obtaining a user's interest point tag provided by an implementation of the disclosure;

FIG. 7 shows another schematic flowchart of a method for displaying a multimedia resource provided by an implementation of the disclosure;

FIG. 8 shows a schematic structural diagram of a device for displaying a multimedia resource provided by an implementation of the disclosure;

FIG. 9 shows another schematic structural diagram of a device for displaying a multimedia resource provided by an implementation of the disclosure; and

FIG. 10 shows a schematic structural diagram of a terminal provided by an implementation of the disclosure.

### DETAILED DESCRIPTION

In order to enable those of ordinary skill in the art to better understand the technical solutions of the disclosure, the technical solutions in some implementations of the disclosure will be described clearly and completely with reference to the accompanying drawings.

It should be noted that the terms “first” and “second” in the specification and claims of the disclosure and the above-mentioned drawings are used to distinguish similar objects, and not necessarily used to describe a specific sequence. It should be understood that the data used in this way can be interchanged under appropriate circumstances so that some implementations of the disclosure described herein can be implemented in a sequence other than those illustrated or described herein. The implementations described in the following example implementations do not represent all implementations consistent with the disclosure. Rather, they are only examples of devices and methods consistent with some aspects of the disclosure as detailed in the appended claims.

It should also be understood that the term “include” or “include” indicates the existence of the described features, entireties, steps, operations, elements, and/or components, but does not exclude the presence or addition of one or more other features, entireties, steps, operations, elements, and/or components.

It should also be understood that the term “at least one of a, b or c” indicates only a, only b, only c, both a and b, both a and c, both b and c, all of a, b, and c, or variations thereof.

At present, multimedia resources such as short videos have become a major information source through which users can obtain information they need. For example, the users can view short videos via some short video applications installed on mobile phones or computers. However, when the users view the short videos, they usually only obtain the content of the short video, and the experience is relatively simple.

Some implementations of the disclosure provide a method for displaying a multimedia resource, through which the users can obtain more services while viewing the multimedia resources (such as the short videos), thereby enriching the user experience.

The method for displaying a multimedia resource provided by some implementations of the disclosure is exemplarily described below with reference to the accompanying drawings.

First, an application scenario of some implementations of the disclosure is described.

FIG. 1 is a schematic diagram of an application scenario provided by an implementation of the disclosure. FIG. 1 shows a server 110 and a terminal 120. The server 110 may establish a connection with the terminal 120 via a wired network or wireless network.

The server 110 may be a data server of some multimedia resource service platforms, and may be configured to store and process the multimedia resources. For example, the multimedia resource service platform may be a short video application service platform, a news service platform, a live broadcast service platform, a shopping service platform, a food delivery service platform, a shared service platform, a functional web site, and the like. The multimedia resources provided by the short video application service platform can be some short videos, the multimedia resources provided by the news service platform can be news information, and the multimedia resources provided by the live broadcast service platform can be live media files and so on. The type of the multimedia resource service platform is not limited in the disclosure.

The terminal 120 may be a personal smart device such as a mobile phone or a tablet computer, or may also be a notebook computer, a desktop computer, or a television and the like. In one implementation, in the application scenario shown in FIG. 1, the server 110 may be connected to at least one terminal 120. The disclosure does not limit the number and types of terminals 120.

The terminal 120 as a mobile phone and the multimedia resource service platform as a short video application service platform are taken as an example.

After a user utilizing a user account enables an application of the short video application service platform installed on the mobile phone, in response to triggering an operation for displaying the target short video through the user account, the mobile phone can acquire a target short video from a server of the short video application service platform, and display the target short video to the user on an application interface of the short video application service platform, so that the user can watch the target short video.

In one implementation, the operation for displaying the target short video may be triggered by the user account through the following touch actions performed by the user utilizing the user account: clicking, sliding and the like on the application interface of the short video application service platform.

In some implementations of the disclosure, the user account or user account mentioned refers to a consumer user account that performs consumption on the multimedia resources (or, it can also be called as an audience user account, and the user account in the following implementations refers to the consumer user account or the audience user account). Consumption refers to consumption behaviors such as viewing the multimedia resources, reposting the multimedia resources, commenting on the multimedia resources, sharing the multimedia resources, and giving a like to the multimedia resources.

In some implementations, the server 110 may be a single server, or may also be a server cluster composed of multiple servers. In some implementations, the server cluster may also be a distributed cluster. The disclosure also does not limit a specific implementation of the server 110.

In some other implementations, the server 110 may also include a database or be connected to the database, and the multimedia resources of the multimedia resource service platform may be stored in the database. The terminal 120 can access to the multimedia resources in the database by means of the server 110.

The method for displaying a multimedia resource provided by some implementations of the disclosure may be applied to the terminal in the application scenario shown in FIG. 1.

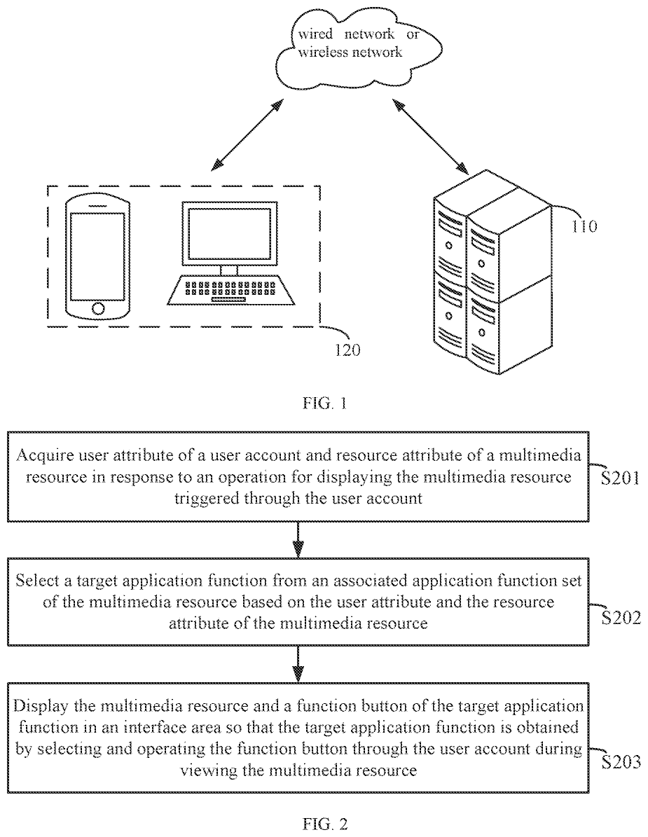

FIG. 2 shows a schematic flowchart of a method for displaying a multimedia resource provided by an implementation of the disclosure.

As shown in FIG. 2, the method for displaying a multimedia resource may include:

In S201, user attribute of a user account and resource attribute of a multimedia resource are acquired in response to an operation for displaying the multimedia resource being triggered through the user account.

In S202, a target application function is selected from an associated application function set of the multimedia resource based on the user attribute and the resource attribute of the multimedia resource.

The associated application function set includes one or more application functions associated with the multimedia resource.

In S203, the multimedia resource and a function button of the target application function are displayed in an interface area so that the user account can select and operate the function button to obtain the target application function during viewing the multimedia resource.

As can be seen from S201-S203, through the method for displaying a multimedia resource, the target application function can be selected from the associated application function set of the multimedia resource based on the user attribute of the user account and the resource attribute of the multimedia resource, and the function button of the target application function is presented, via the interface area, to the user account together with the multimedia resource. Therefore, when the multimedia resource is viewed through the user account, the target application function can also be obtained by operating the function button of the target application function. That is, through the method for displaying a multimedia resource, application functions are provided to the user by dynamically matching current user attributes and resource attributes of the multimedia resources when the user views the multimedia resources. In this way, the user can quickly obtain application function services that meet their own needs while viewing the multimedia resources, thereby enriching user experience.

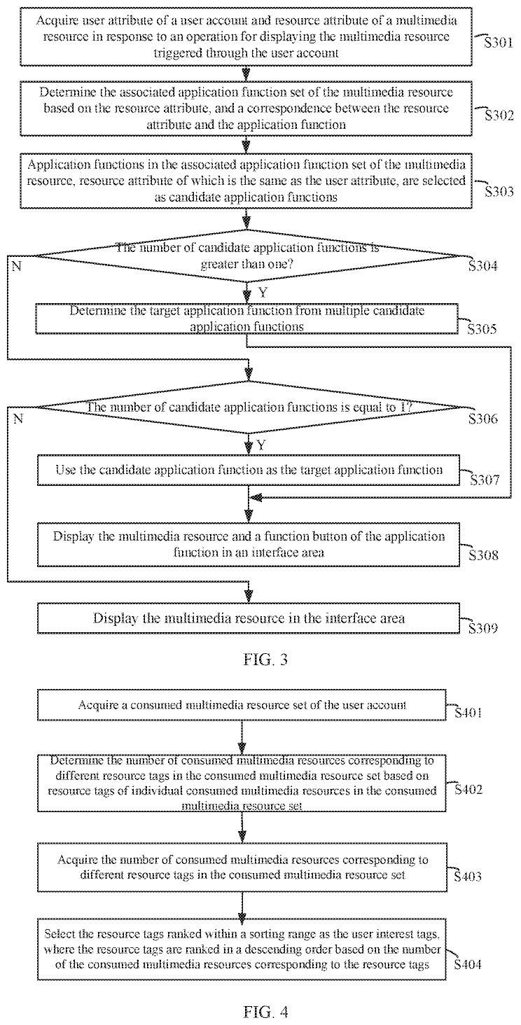

The method for displaying a multimedia resource will be described below in conjunction with FIG. 3.

FIG. 3 shows another schematic flowchart of a method for displaying a multimedia resource provided by an implementation of the disclosure.

As shown in FIG. 3, the method for displaying a multimedia resource may include:

In S301, user attribute of a user account and resource attribute of a multimedia resource are acquired in response to the operation for displaying the multimedia resource being triggered through the user account.

The operation for displaying the multimedia resource may be triggered by the user account through actions such as clicking and sliding performed on the terminal by the user utilizing the user account. For example, the actions may be the following actions performed by the user: an operation for clicking and enabling the application of the multimedia resource service platform on the terminal; a refresh operation by clicking or sliding on the application interface of a certain multimedia resource service platform on the terminal. In response to the terminal detecting that the operation for displaying the multimedia resource is triggered by the user account, the user attribute of the user account and the resource attribute of the multimedia resource can be obtained.

In some implementations of the disclosure, different multimedia resource service platforms can provide different multimedia resources. Correspondingly, for the trigger operations of different applications on the terminal, the corresponding multimedia resources to be displayed may also be different. For example, the multimedia resources can be short videos, news information, live broadcast, web pages, and so on.

In one implementation, the resource attribute of the multimedia resource may at least include a resource tag of the multimedia resource.

In some implementations, the resource attribute of the multimedia resource may be acquired by: acquiring at least one of resource title information, resource introduction information, geographic position information, and author information of the multimedia resource; and extracting the resource tags of the multimedia resource based on at least one of the resource title information, the resource introduction information, the geographic position information, and the author information of the multimedia resource. For example, a content tag can be extracted based on the resource title information or resource introduction information of the multimedia resource. A geographic position tag can be extracted based on the geographic position information of the multimedia resource. An author tag can be extracted based on the author information of the multimedia resource. The content tag, the geographic position tag, the author tag, etc., are the resource tags of the multimedia resource.

In other implementations, the resource attribute of the multimedia resource may be further acquired by: acquiring a resource production template and/or a resource production special effect for the multimedia resource; and extracting resource tags of the multimedia resource based on the resource production template and/or the resource production special effect for the multimedia resource. For example, a template tag can be extracted based on the resource production template of the multimedia resource. A magic emoticon tag can be extracted based on the resource production special effect of the multimedia resource. That is, the resource tags of the multimedia resource may further include the template tag, the magic emoticon tag, etc.

In some other implementations, the resource attribute of the multimedia resource may further be acquired by: performing audio recognition and/or video recognition on the multimedia resource to obtain resource content of the multimedia resource; and extracting resource tags of the multimedia resource based on the resource content of the multimedia resource. The resource tag can also be the content tag of the multimedia resource.

Taking the multimedia resource as the short video work as an example, the resource tag such as the content tag, the geographic position tag, the author tag, the template tag, and the magic emoticon tag is exemplarily described.

For the short video work, an audio/video recognition technology can be used to identify and acquire the specific content of the short video work, so as to determine the content tag of the short video work. For example, it can be known through the video recognition technology that the content of the short video work may be food, music, movies, news, games and the like, then the content tag of the short video work may be food, music, movies, news, or games respectively. Alternatively, it can be known through the audio recognition technology that the content of the short video work may be opera, song and the like, then the content tag of the short video work maybe opera, song respectively.

Alternatively, the short video work usually have a corresponding work title (resource title information), work introduction (resource introduction information), etc. The content tag of the short video work can also be acquired by extracting the work title or work introduction of the short video work through word segmentation processing. For example, if the title of a short video work is “Delicious braised pork in brown sauce”, the word “braised pork in brown sauce” can be extracted from the title. Since “braised pork in brown sauce” belongs to food, the content tag of the short video work can be food.

In the example in which the content of the short video work is scenery of a certain scenic spot, or the content of the short video work involves certain places, the geographic position tag of the short video work can be an address of the scenic spot, or an address of a place involved in the content of the short video work. For example, if the short video work is a food video of a restaurant, the geographic position tag of the short video work may be the address of the restaurant. Alternatively, the geographic position tag of the short video work may also be the geographic position of the user who uploaded the short video work, etc., which is not limited in the disclosure.

The author tag can be classified based on a type of the author of the short video work. For example, the author who makes the short video work may be a food author, a news author, a celebrity author, a music author, etc., and the author tag of the short video work may be the food author, the news author, the celebrity author, or the music author.

For some short video service platforms, the corresponding applications may also include some short video production templates or some magic emoticons. For example, the short video production templates may include: a music template, a background template, and so on. Magic emoticons can include: “Little Cat”, “Black Sunglasses”, “Long Legs and Slimming”, “Ink Painting” and so on. The author of the short video work can use the short video production templates to shoot or produce the short video work. Alternatively, the magic emoticons may be added to the short video while shooting or producing the short video work. For such short video work, the corresponding work tags may further include: a template tag and a magic emoticon tag. The template tag is a short video production template used when shooting or making the short video work, and the magic emoticon tag is the magic emoticon added in the short video work. The short video service platform can automatically identify and obtain the template tag and the magic emoticon tag of the short video work in which the short video production templates and/or magic emoticons are used.

In one implementation, for any multimedia resource, the resource tag of the multimedia resource can be obtained by referring to the aforementioned method. Alternatively, when the author of the multimedia resource makes or uploads the multimedia resource, he can add resource tags to the multimedia resource according to the above-mentioned resource tag classification method, which is not limited in the disclosure.

In one implementation, the user attribute of the user account may at least include user interest tags. The user attribute of the user account may be acquired by: analyzing some historical multimedia resources frequently consumed (such as browsing, giving likes, reposting, etc.) through the user account, so as to extract the user interest tag of the user account. For example, the resource tags of some historical multimedia resources frequently consumed through the user account can be counted, and then the counted resource tags can be used as the user interest tags of the user account.

Hereinafter, in conjunction with FIG. 4, an example of the manner of obtaining the user interest tag of the user account in an implementation of the disclosure will be described.

FIG. 4 shows a schematic flowchart of obtaining the user interest tag provided by an implementation of the disclosure.

As shown in FIG. 4, in an implementation, the user interest tag of the user account may be obtained by operations describe below.

In S401, a consumed multimedia resource set of the user account is acquired.

The consumed multimedia resource set includes at least one consumed multimedia resource consumed through the user account within a first time period, and the consumed multimedia resources at least include one of multimedia resources that the user account has viewed, commented on, shared or given likes.

The first time period may be the past y hours, the past y days, the past y weeks, the past y months, etc., and y is greater than zero. For example, y can be any number greater than 0 such as 2.5, 5, 6, 8, 9.2. The disclosure does not limit a specific duration of the first time period.

By acquiring the consumed multimedia resources consumed by the user in the first time period, the consumed multimedia resource set of the user can be obtained. The consumed multimedia resource set may include one or more consumed multimedia resources. As described in the foregoing implementations, consumption refers to consumer behaviors performed by the user, such as viewing media files, reposting media files, commenting on media files, sharing media files, and giving likes to media files. Correspondingly, the consumed multimedia resources refer to the multimedia resources for which the user has performed the aforementioned consumption behavior. For example, the user has watched short video work 1, reposted short video work 2, etc., then the short video work 1 and the short video work 2 are both consumed multimedia resources of the user.

In S402, the number of consumed multimedia resources corresponding to different resource tags in the consumed multimedia resource set is determined based on resource tags of individual consumed multimedia resources in the consumed multimedia resource set.

As mentioned in the foregoing description of the multimedia resources, the resource tags of the multimedia resources may include any one or more of the geographic position tag, the content tag, the author tag, the template tag, and the magic emoticon tag. The resource tags of the consumed multimedia resources as the multimedia resources consumed by the user may also include any one or more of the geographic position tag, the content tag, the author tag, the template tag, and the magic emoticon tag. That is, each consumed multimedia resource in the consumed multimedia resource set has a corresponding resource tag. Of course, it can be understood that the resource tags of different consumed multimedia resources may be the same or different.

After obtaining the consumed multimedia resource set of the user, the number of consumed multimedia resources corresponding to different resource tags may be determined based on resource tags of individual consumed multimedia resources in the consumed multimedia resource set.

For example, assuming that the consumed multimedia resource set of a certain user account is shown in Table 1 below:

TABLE 1

| consumed multimedia resource | resource tag |
|---|---|
| consumed multimedia resource 1 | Music tag |
| consumed multimedia resource 2 | Music tag, game tag |
| consumed multimedia resource 3 | News tag |
| consumed multimedia resource 4 | Magic emoticon1 |
| consumed multimedia resource 5 | game tag |
| consumed multimedia resource 6 | game tag |

As shown in Table 1, the consumed multimedia resource set of the user account includes: consumed multimedia resource 1, consumed multimedia resource 2, consumed multimedia resource 3, consumed multimedia resource 4, consumed multimedia resource 5, and consumed multimedia resource 6. The resource tag of the consumed multimedia resource 1 includes the music tag. The resource tags of the consumed multimedia resource 2 include the music tag and the game tag. The resource tag of the consumed multimedia resource 3 includes the news tag. The resource tag of the consumed multimedia resource 4 includes the magic emoticon 1. The resource tags of the consumed multimedia resource 5 and the consumed multimedia resource 6 are both game tags.

Then, based on the resource tags of each consumed multimedia resource in the consumed multimedia resource set of the user account, it can be determined that the number of consumed multimedia resources corresponding to the music tag is two (including the consumed multimedia resource 1 and the consumed multimedia resource 2). The number of consumed multimedia resources corresponding to the game tag is three (including the consumed multimedia resource 2, the consumed multimedia resource 5, and the consumed multimedia resource 6). The number of consumed multimedia resources corresponding to the news tag is one (including the consumed multimedia resources 3). The number of consumed multimedia resources corresponding to the magic emoticon 1 is one (including the consumed multimedia resource 4).

In some implementations, in S402, in response to determining that the number of consumed multimedia resources corresponding to different resource tags in the consumed multimedia resource set based on resource tags of individual consumed multimedia resources in the consumed multimedia resource set, the number of consumed multimedia resources corresponding to different resource tags can be counted according to the pre-divided types of different resource tags.

In some other implementations, the resource tags of all the consumed multimedia resources in the consumed multimedia resources set may also be acquired first to obtain at least one type of resource tag. Then, based on the different types of the acquired resource tags, the number of consumed multimedia resources corresponding to the different resource tags is counted, which is not limited in the implementation of the disclosure.

After the number of consumed multimedia resources corresponding to different resource tags is obtained in S402, the user interest tags can be obtained through S403 and S404.

In S403, the number of consumed multimedia resources corresponding to different resource tags in the consumed multimedia resource set is acquired.

In S404, the resource tags ranked within a sorting range are selected as the user interest tags, where the resource tags are ranked in a descending order based on the number of the consumed multimedia resources corresponding to the resource tags.

That is, it is possible to sort, based on the number of consumed multimedia resources, all the resource tags for the consumed multimedia resource set in the descending order. For example, the more the corresponding consumed multimedia resources, the higher the ranking of the resource tag. Then, the resource tags whose sorting order is within the sorting range can be selected from the descending sorting result as the user interest tags of the user account.

The sorting range may be the first N rankings, or the Nth ranking to the N+N1 ranking. N or N1 can be an integer greater than zero. For example, N or N1 can be 1, 2, 3, 4, etc.

Taking the sorting range as the first N ranking as an example, the resource tags with the first N rankings can be selected from the descending sorting result of the resource tags and be served as the interest point tags of the user account. For example, if the resource tags ranked in the first N include: the news tag and the game tag. Then, the news tag and the game tag can be used as the user interest tags of the user account.

Also taking the above Table 1 as an example, in the consumed multimedia resource set shown in Table 1, the number of consumed multimedia resources corresponding to the music tag is 2, the number of consumed multimedia resources corresponding to the game tag is 3, the number of consumed multimedia resources corresponding to the news tag is 1, and the number of consumed multimedia resources corresponding to the magic emoticon 1 is 1. Assuming that N is 1, the interest point tag of the user account is the game tag corresponding to which the number of consumed multimedia resources is ranked first.

In one implementation, in this implementation, the user interest tag of the user account may be acquired offline in advance, or acquired online in real time. Compared with the online real-time acquisition method, the pre-offline acquisition method can reduce the amount of online calculations in response to the method for displaying a multimedia resource being performed, thus the execution efficiency is improved, thereby achieving higher timeliness. However, it should be noted that some implementations of the disclosure do not limit the pre-offline acquisition or the online real-time acquisition.

After the user attribute of the user account and the resource attribute of the multimedia resource are acquired in S301, the target application function is selected from the associated application function set of the multimedia resource based on the user attribute, and the function button of the target application function is displayed together with the multimedia resource. For example, please continue to refer to FIG. 3, the method may further include S302-S309.

In S302, the associated application function set of the multimedia resource is determined based on the resource attribute of the multimedia resource and a correspondence between the resource attribute and the application function.

The associated application function set may include one or more application functions associated with the multimedia resource.

In some implementations of the disclosure, the correspondence between the resource attribute and the application function can be preset. For example, the correspondence between the resource attribute and the application function can be preset in the server or terminal.

Taking the multimedia resource as a short video work as an example, the correspondence between the resource attribute and the application function is described in detail below.

As mentioned in the foregoing S301, the resource attribute of the short video work may be the resource tags such as the geographic position tag, the content tag, the author tag, the template tag, and the magic emoticon tag. In the correspondence between the resource attribute and the application function, the application function corresponding to the geographic position tag may be entry links of other short videos with the same geographic position tag, or entry links of other short videos related to the geographic position indicated by the geographic position tag. For example, if the geographic position tag of a short video work is position B of a certain restaurant, the application function corresponding to the geographic position tag can be an entry link of an introduction for the restaurant, entry links of other short videos that also contain the geographic position tag.

The application function corresponding to the content tag may be the entry links of other short videos that also has the same content tag, or the entry links of other short videos related to the content tag. For example, if the content tag of a certain short video work is the music tag, the application function corresponding to the content tag may be the entry links of other short videos whose content tag is also the music tag.

Similarly, the application function corresponding to the author tag, the template tag, or the magic emoticon tag can be the entry links of other short videos with the same author tag, the same template tag, or the same magic emoticon tag, or the entry links of other short videos related to the author tag, the template tag, or the magic emoticon tag.

In some implementations, the resource tags can be further refined. For example, the music tag and the game tag can be refined into specific music types, music names, game types, game names, etc.

For example, if the background music used in a certain short video work is song Z, the content tag of the short video work may include: song Z. If the content of a certain short video work is an explanation video of a game M, the content tag of the short video work may include: game M.

Correspondingly, for further refined resource tags, the correspondence between the resource attribute and the application function can also be further refined. For example, if the content tag of a certain short video work is the song Z, the corresponding application function may be the entry links of other short videos that also use the song Z as the background music. If the content tag of a certain short video work is the game M, the corresponding application function can be an entry link for downloading the game M or entering the game M. If the content tag of a certain short video work is a product G, the corresponding application function may be a purchase link of the product G, etc.

Similarly, the magic emoticon tag can be refined into a specific magic emoticon, and the corresponding application function can be an entry link of other short videos that use the same magic emoticon, or a shooting entry that uses the magic emoticon to shoot. The template tag can be refined into a specific short video production template, and the corresponding application function can be the entry links of other short videos that use the same short video production template, or the shooting entry that uses the short video production template to shoot.

Based on the correspondence between the resource attribute and the application function, it is possible to determine application functions corresponding to the resource attribute of the multimedia resource, thereby obtaining the associated application function set of the multimedia resource.

It should be noted that, for applications provided by different multimedia resource service platforms, some application functions may be restricted or not supported. In actual implementation, some implementations of the disclosure may also be combined with the support capabilities of the actual application to determine the application functions that can be supported by the application displaying the multimedia resource, which will not be repeated here.

In one implementation, in the correspondence between the resource attribute and the application function, each resource tag may correspond to one or more application functions, and different resource tags may correspond to the same application function, which is not limited in the disclosure.

In S303, application functions in the associated application function set of the multimedia resource, resource attribute of which is the same as the user attribute, are selected as candidate application functions.

Take the user account as account P and the multimedia resource as short video work Q as an example.

First, the resource attribute of the short video work Q and the associated application function set of the short video work Q can be obtained through the methods described in S301 and S302. Then, based on the user attribute of the account P, the application function resource attribute of which is the same as the user attribute of the account P is selected from the associated application function set of the short video work Q as an candidate application function.

For example, assuming that the associated application function set of the short video work Q includes the following application functions: K1, K2, and K3, and the resource attribute corresponding to K1 is T1, the resource attribute corresponding to K2 is T2, and the resource attribute corresponding to K3 is T3. The user attribute of the account P includes: T2 and T3. As can be seen, among the associated application function set of the short video work Q, the resource attribute T2 and T3 corresponding to the application functions K2 and K3, respectively, are the same as the user attribute of the account P. The application functions K2 and K3 can be selected as the candidate application functions.

It can be understood that the candidate application functions determined in S303 may include one or more, or may also be zero. In the example in which the number of candidate application functions is one or more, one of such application functions may be selected as the target application function. For example, S304-S307 can be executed.

In S304, it is determined whether the number of candidate application functions is greater than one.

If the number of candidate application functions is greater than 1 (it means that multiple candidate application functions are determined), then S305 can be executed. If the number of candidate application functions is not greater than 1 (that is, equal to 1 or equal to 0), then S306 may be executed.

In S305, the target application function is determined from the multiple candidate application functions.

In one implementation in which there are multiple candidate application functions, popularity of each of the candidate application functions in a second time period can be acquired first. Then, the target application function can be determined from the multiple candidate application functions based on the popularity of each of the candidate application functions in the second time period.

The second time period is similar to the first time period, and can be the past y hours, the past y days, the past y weeks, the past y months, etc., and y is greater than zero. The disclosure also does not limit the specific duration of the second time period.

In some implementations, the popularity of the candidate application function in the second time period may refer to the displaying count (or the displaying number) of the candidate application function in the second time period. For example, if a certain candidate application function is a short video work, the popularity (the displaying count) of the candidate application function may be the video view of the short video work in the second time period, and the video view is the number of times other users watched the short video work. When the popularity of the candidate application function in the second time period refers to the displaying count of the candidate application function in the second time period, determining the target application function from the multiple candidate application functions based on the popularity of each of the candidate application functions in the second time period may refer to: selecting the candidate application function that has the maximum displaying count in the second time period as the target application function from the candidate application functions.

Of course, in some implementations, it is also possible to select the candidate application functions whose displaying count is ranked first two, three, or more from the multiple candidate application functions. That is, multiple target application functions can be determined, which is not limited in the disclosure.

In other implementations, the popularity of the candidate application function in the second time period may also refer to any one of the followings: the number of sharing, the number of likes, the number of comments, and the number of reposting of the candidate application function in the second time period. Alternatively, it may also be based on any combination of the displaying count, the number of sharing, the number of likes, the number of comments, and the number of reposting to calculate the popularity of the candidate application function in the second time period. For example, the average value of the displaying count, the number of sharing, the number of likes, the number of comments, and the number of reposting can be calculated as the popularity of the candidate application function in the second time period. The disclosure also does not limit the specific method for determining the popularity of the candidate application function

In S306, it is determined whether the number of candidate application functions is equal to 1.

If the number of candidate application functions is equal to 1, S307 is executed.

In S307, the candidate application function is used as the target application function.

After the target application function is determined according to the aforementioned S304-S307, S308 can be executed to display the multimedia resource and the function button of the target application function.

In S308, the multimedia resource and the function button of the target application function are displayed in the interface area.

In the interface area, the multimedia resource and the function button of the target application function are displayed, so that the user account can select to operate the function button of the target application function to obtain the target application function while viewing the multimedia resource. For example, other short videos can be viewed, a shooting entry to the short video work is entered, a shopping link of some goods is entered, and a play or download link of some music is entered, etc.

However, it should be note that if it is determined in S306 that the number of candidate application functions is not equal to 1, it means that the number of candidate application functions is 0 (S304 and S305 have excluded a case where the number of candidate application functions is greater than 1). At this time, only the multimedia resource may be displayed, and the function button of the target application function may not be displayed. For example, if the number of candidate application functions in S306 is not equal to 1, S309 may be executed.

In S309, the multimedia resource is displayed in the interface area.

The interface area may refer to the application interface of the multimedia resource service platform, and the application interface may be displayed by a display of the terminal.

In one implementation, in S308, the multimedia resource may be displayed in the interface area. The function button of the target application function can be displayed in a first area of the interface area. For example, if the function button of the target application function is an entry link of a certain short video work, in response to the user clicking the entry link, the interface of the short video work can be displayed, and the user can consume the short video work.

In some implementations, the interface area includes a user information area that provides the multimedia resource. The first area may be an associated display area of the user information area in the interface area. For example, the user information area may be an area where the user avatar area is located, and the first area may be an area above or below the area where the user avatar is located in the interface area.

In other implementations, when the function button of the target application function is displayed, a control display style corresponding to the target application function can also be acquired. For example, the control display style may at least include a size, icon, special effect, etc. for displaying the function button. Then, the function button of the target application function can be displayed according to the obtained control display style. For example, according to the control display style, different special effects such as light emission, flashing, color, etc. can be added to the display area of the function button to attract the user's attention. Alternatively, the size and icon type of the function button can be set according to the control display style. A display area for displaying the function button according to the control display style may be the same area as the first area or a different area.

In some other implementations, the first area may also be an edge area of the interface area where the multimedia resource is displayed, which is not limited in this disclosure.

As an example, the multimedia resource is also taken as the short video work.

FIG. 5 shows a schematic diagram of a display interface provided by an implementation of the disclosure.

As shown in FIG. 5, the display interface is a display interface of a certain short video work. In the display interface, area 1 is an area above the area where the user avatar is located, area 2 is an edge area of the display interface, and area 3 is a special effect area of the display interface (the special effect area refers to a display area where the function button is displayed according to the display style of the control). The first area for displaying the function button of the target application function of the short video work can be any one of area 1, area 2 and area 3. It should be noted that positions of area 1, area 2 and area 3 in the display interface shown in FIG. 5 are merely example descriptions, and are not used to limit their specific positions.

For example, area 2 may also be located at an upper left corner, a lower left corner, etc. of the display interface. The position of area 1 can vary with the position of the user avatar. For example, in display interfaces of different service platforms, the user avatar may be laid out in different areas of the display interface. However, no matter how the area of the user avatar changes, area 1 can be the area above the area where the user avatar is located. Area 3 may overlap with the upper area of the area where the user avatar is located, or overlap with the edge area of the display interface. That is, area 3 may be the same area as area 1 or area 2. For example, the function button of the target application function can be displayed in area 1 or area 2, and special effects such as light emission, flashing, and color can be added in area 1 or area 2.

Some implementations of the disclosure, in response to an operation for displaying the multimedia resource being triggered through the user account, acquire user attribute of a user account and resource attribute of a multimedia resource, select a target application function from an associated application function set of the multimedia resource based on the user attribute and the resource attribute of the multimedia resource, and then display the multimedia resource and a function button of the target application function in an interface area so that the function button may be selected and operated to obtain the target application function during viewing the multimedia resource through the user account. In this way, the application functions are provided to the user by dynamically matching the current user attributes and the resource attributes of the multimedia resources when the user views the multimedia resources, and the user can quickly obtain application function services that meet their own needs while viewing the multimedia resources, thereby enriching user experience.

In one implementation, in other implementations of the disclosure, a trained interest recognition model can also be obtained by a deep learning training manner, and then the user interest point tag identification model is used to predict the user interest tag of the user account to obtain the user interest tag of the user account.

In one implementation, a sample set used to train the interest recognition model can be obtained. The sample set may include consumption behavior data on multimedia resources of at least one user account and a user portrait of the user account. The consumption behavior data includes consumption behavior types and resource tags of the multimedia resources. The user portrait can include at least one of user age, user gender, a user position, and a user's multimedia resource preference type. For example, the user portrait of the user can be constructed according to the user age, gender, geographic position, and configured user preference information. The user preference information may refer to: the user likes music, games, sports, etc. After the sample set is obtained, the sample set can be used to train a type of neural network to obtain the interest recognition model.

For example, the sample set may include consumption behavior data on the multimedia resources of different user accounts and corresponding user portraits. The consumption behavior data on the multimedia resources of each user account and the corresponding user portrait can be used as a training sample group. Then, each training sample group can be used separately to train the type of neural network with the user portrait in the training sample as an input and with the consumption behavior data on multimedia resources as an output, so as to obtain the interest recognition model.

In one implementation, the type of neural network may be a supervised learning network, an unsupervised learning network, a hybrid learning network, etc., which is not limited in the disclosure.

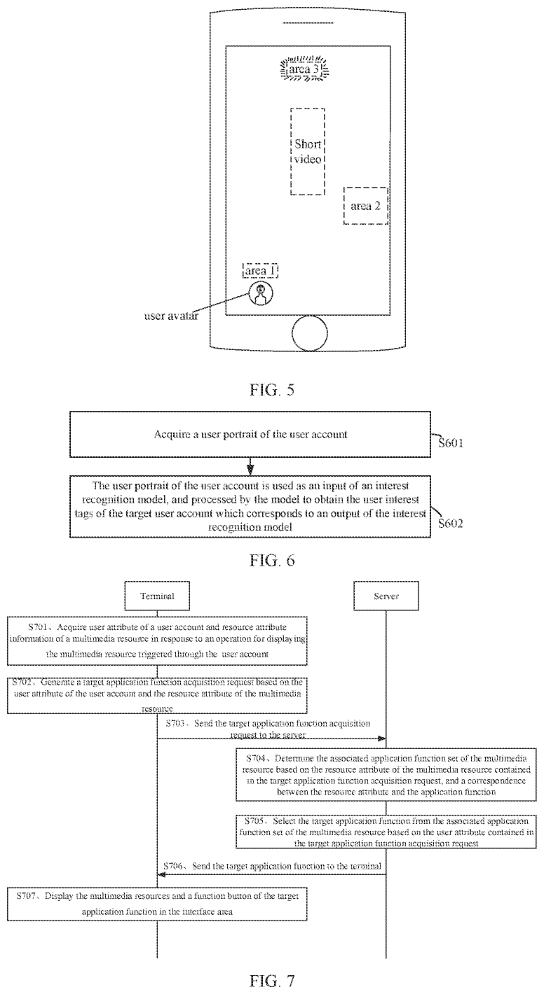

The interest recognition model obtained by the above training can output the corresponding user interest tag according to the input user portrait. For example, FIG. 6 shows another schematic flowchart of obtaining a user interest tag provided by an implementation of the disclosure. As shown in FIG. 6, the user interest tag of the user account may be obtained based on the above-mentioned interest recognition model through the following operations.

In S601, a user portrait of the user account is acquired.

In S602, the user portrait of the user account is used as an input of an interest recognition model, and processed by the model to obtain the user interest tags of the user account which corresponds to an output of the interest recognition model.

Similarly, in this implementation, the user interest tag may be obtained in an offline manner in advance or obtained in an online manner in real time. For example, in response to browsing a short video work through a certain user account or enabling a short video application, the interest point tag recognition model can be used to determine the user interest tags of the user account. Regarding the beneficial effects of pre-offline acquisition or online real-time acquisition, it is the same as or similar to the foregoing implementations, and the details will not be repeated here.

In some possible implementations, in response to determining that in S306 that the number of candidate application functions is 0, an application function randomly selected from the associated application function set of the multimedia resource may be used as the target application function. The function button of the target application and the multimedia resource are displayed together in the interface area. Alternatively, an application function selected from the associated application function set of the multimedia resource according to other rules (such as application function popularity, update time) may also be used as the target application function, which is not limited in the disclosure.

In one implementation, in the operation of obtaining user interest tags shown in FIG. 4, the operation of determining the number of consumed multimedia resources corresponding to different resource tags in the consumed multimedia resource set based on resource tags of individual consumed multimedia resources in the consumed multimedia resource set in S402 may also be: determining the number of consumed multimedia resources corresponding to different consumption behaviors in the consumed multimedia resources corresponding to the different resource tags based on the resource tags of individual consumed multimedia resources in the consumed multimedia resource set and the corresponding consumption behaviors (where the consumption behaviors include at least one of behavior of viewing, commenting on, sharing or giving likes to the multimedia resources); and then determining the number of consumed multimedia resources corresponding to the different resource tags based on the number of consumed multimedia resources corresponding to different consumption behaviors in the consumed multimedia resources corresponding to different resource tags and weight values of different consumption behaviors.

The following situation is taken as an example: the multimedia resources are short videos, the consumption behaviors include viewing, sharing, giving likes and commenting, and a weight value corresponding to viewing is a1, a weight value corresponding to sharing is a2, a weight value corresponding to giving likes is a3, and a weight value corresponding to commenting is a4.

For a consumed short video work set of a certain user account, assuming that among consumed short videos corresponding to a resource tag 1 (for example, when the resource tag 1 is the geographic position tag, the resource tag 1 can be Beijing, Shanghai, etc.), the number of consumed short videos viewed by the user account is X1, the number of consumed short videos shared by the user account is X2, the number of consumed short videos have been given likes through the user account is X3, and the number of consumed short videos commented through the user account is X4. Then, the number of consumed short videos corresponding to the resource tag 1 can be calculated as follows:

the number of consumed short videos corresponding to the resource tag 1=X1*a1+X2*a2+X3*a3+X4*a4, where “*” means multiplication.

Similarly, according to the calculation method of the number of consumed short videos corresponding to the resource tag 1, the number of consumed short videos corresponding to different resource tags in the consumed short video work set can be obtained. It should be noted that the foregoing consumption behavior and the weight value for the consumption behavior are merely example illustrations. In actual implementation, the consumption behavior may also include more different types such as enshrining, reposting, downloading, etc. The weight values of different consumption behaviors may also be the same or different, and the disclosure does not limit this.

Compared to directly counting the number of consumed multimedia resources corresponding to different resource tags, the determined number of consumed multimedia resources corresponding to each resource tag is more closely related to the consumption behavior by determining the number of consumed multimedia resources corresponding to the different resource tags based on the number of consumed multimedia resources corresponding to different consumption behaviors and weight values of different consumption behaviors. By setting corresponding weight values of different consumption behaviors, more accurate statistics can be achieved for the number of consumed multimedia resources corresponding to each resource tag, and the subsequent determined user interest tags can also be closer to the type of interest of the user account. For example, the weight value for the giving likes behavior can be set to be higher, and the weight value for the browsing behavior can be set to be lower. Then, the determined resource tag corresponding to the largest number of consumed multimedia resources will be closer to the type of the resource tag of the multimedia resource liked by the user account, that is, it will be closer to the type of interest of the user account.

The above description mainly introduces the solutions provided by some implementations of the disclosure from the perspective of the terminal. However, it is understandable that, in the above method for displaying a multimedia resource, some operations can actually be completed by a server. For example, in the method for displaying a multimedia resource, the operation of selecting, by the terminal, a target application function from an associated application function set of the multimedia resource based on the user attribute and the resource attribute of the multimedia resource may include: sending a target application function acquisition request including the user attribute and the resource attribute of the multimedia resource to the server; and triggering the server to select and return the target application function from the associated application function set of the multimedia resource. That is, the terminal may send the target application function acquisition request to the server, and the server may return the target application function to the terminal based on the target application function acquisition request. In this process, the operation of selecting the target application function from the associated application function set of the multimedia resource may actually be performed by the server.

Based on this understanding, some implementations of the disclosure further provide a method for displaying a multimedia resource. This method can be applied to the server shown in FIG. 1. In the method for displaying a multimedia resource, the server may receive a target application function acquisition request sent by a terminal. The target application function request includes user attribute and resource attribute of a multimedia resource. After the terminal obtained the user attribute of the user account and the resource attribute of the multimedia resource in response to an operation for displaying the multimedia resource being triggered through the user account, the target application function acquisition request is generated by the terminal based on the user attribute of a user account and the resource attribute of the multimedia resource. Then the server may select the target application function from an associated application function set of the multimedia resource according to the target application function acquisition request, and return the target application function to the terminal, so that the terminal displays the multimedia resource and a function button of the target application function in an interface area. In this way, the user account can select and operate the function button to obtain the target application function while viewing the multimedia resource.

The associated application function set may include one or more application functions associated with the multimedia resource.

The implementation is described with reference to FIG. 7 by illustrating a specific process of interaction between the server and the terminal.

FIG. 7 shows another schematic flowchart of a method for displaying a multimedia resource provided by an implementation of the disclosure. As shown in FIG. 7, the method for displaying a multimedia resource may include operations described below.

In S701, the terminal acquires user attribute of a user account and resource attribute of a multimedia resource in response to an operation for displaying the multimedia resource being triggered through the user account.

In S702, the terminal generates a target application function acquisition request based on the user attribute of the user account and the resource attribute of the multimedia resource.

The target application function request includes the user attribute and the resource attribute of the multimedia resource.

In S703, the terminal sends the target application function acquisition request to the server.

In S704, the server determines the associated application function set of the multimedia resource based on the resource attribute of the multimedia resource contained in the target application function acquisition request, and a correspondence between the resource attribute and the application function.

In S705, the server selects the target application function from the associated application function set of the multimedia resource based on the user attribute contained in the target application function acquisition request.

In one implementation, the method for the server to select the target application function from the associated application function set of the multimedia resource according to the target application function acquisition request may refer to the method for selecting the target application function described on the terminal side.

For example, the server may select application functions from the associated application function set of the multimedia resource, resource attribute of which is the same as the user attribute contained in the target application function acquisition request, as candidate application functions. The server uses the candidate application function as the target application function if one candidate application function is determined. The server determines the target application function from multiple candidate application functions if multiple candidate application functions are determined.

In response to the server determining that the target application function from multiple candidate application functions, the server may first acquire popularity of each of the candidate application functions in a second time period. Then, the server may determine the target application function from the candidate application functions based on the popularity of each of the candidate application functions in the second time period.

In S706, the server sends the target application function to the terminal.

In S707, the terminal displays the multimedia resources and a function button of the target application function in the interface area.

The relevant explanations about the operations performed by the terminal are the same as those described in the foregoing implementation, and will not be repeated here.

In addition, it needs to be noted, in the case that the number of application functions in the associated application function set that have the same resource attribute as the user attribute contained in the target application function acquisition request is 0 when the server, in S705, selects the target application function from the associated application function set of the multimedia resource based on the user attribute contained in the target application function acquisition request, the server can randomly select a target function as the target application function, or no target application function is determined by the server. In response to determining no target application function, the content displayed by the terminal in the interface area in S707 only includes the multimedia resource, and does not include the function button of any target application function.

It is understandable that, in actual implementation, the terminal/server described in the implementation of the disclosure may include one or more hardware structures and/or software modules for implementing the corresponding method for displaying a multimedia resource, and these execution hardware structures and/or software modules can constitute an electronic device. Those of ordinary skill in the art will easily appreciate that the example algorithm operations described according to some implementations disclosed herein can be carried out by electronic hardware or a combination of electronic hardware and computer software. Whether the functions are implemented by hardware or software depends on particular applications and design constraints of the technical solutions. For each of the particular applications, a person skilled in the art can use different methods to implement the described functions, but such implementation should not be considered as beyond the scope of the disclosure.

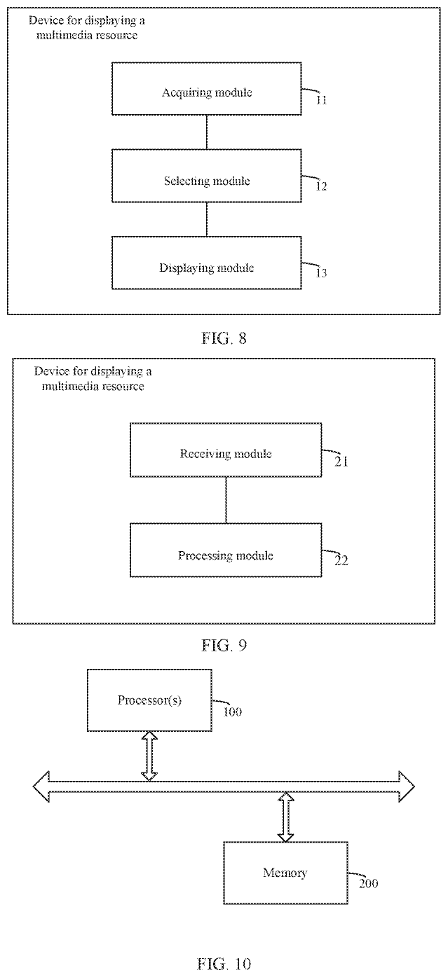

Based on such understanding, some implementations of the disclosure further provide a device for displaying a multimedia resource, and the device can be applied to a terminal. FIG. 8 shows a schematic structural diagram of a device for displaying a multimedia resource provided by an implementation of the disclosure. As shown in FIG. 8, the device for displaying a multimedia resource may include:

an acquiring module 11, configured to acquire user attribute of a user account and resource attribute of a multimedia resource in response to an operation for displaying the multimedia resource being triggered through the user account; a selecting module 12, configured to select a target application function from an associated application function set of the multimedia resource based on the user attribute and the resource attribute of the multimedia resource, where the associated application function set includes one or more application functions associated with the multimedia resource; and a displaying module 13, configured to display the multimedia resource and a function button of the target application function in an interface area so that the user account can select to operate the function button to obtain the target application function during viewing the multimedia resource.

In one implementation, the user attribute may at least include user interest tags.

In some implementations, the acquiring module 11 is configured to: acquire a consumed multimedia resource set of the user account, where the consumed multimedia resource set includes at least one consumed multimedia resource consumed through the user account within a first time period, and the consumed multimedia resources include at least one multimedia resource which are viewed, commented on, shared or liked through the user account; determine the number of consumed multimedia resources corresponding to different resource tags in the consumed multimedia resource set based on resource tags of individual consumed multimedia resources in the consumed multimedia resource set; acquire the number of consumed multimedia resources corresponding to different resource tags in the consumed multimedia resource set; and select the resource tags ranked within a sorting range as the user interest tags of the user account, where the resource tags are ranked in a descending order based on the number of the corresponding consumed multimedia resources.

In a possible implementation, the acquiring module 11 is configured to: determine the number of consumed multimedia resources corresponding to different consumption behaviors in the consumed multimedia resources corresponding to different resource tags based on the resource tags of individual consumed multimedia resources in the consumed multimedia resource set and the corresponding consumption behaviors, where the consumption behaviors include at least one behavior of viewing, commenting on, sharing or giving likes to the multimedia resources; and determine the number of consumed multimedia resources corresponding to different resource tags based on the number of consumed multimedia resources corresponding to different consumption behaviors in the consumed multimedia resources corresponding to different resource tags and weight values for different consumption behaviors.

In other implementations, the acquiring module 11 is configured to: acquire a user portrait of the user account, where the user portrait at least includes one of a user age, user gender, a user position, and a user multimedia resource preference type. The user portrait of the user account is used as an input of an interest recognition model, and processed by the model to obtain the user interest tags of the user account as an output.

The interest recognition model is a model obtained by training an acquired sample set according to a type of neural network, and is used for outputting the corresponding user interest tag according to the input user portrait. The sample set includes consumption behavior data of at least one user for multimedia resources and a user portrait of the user, and the consumption behavior data includes consumption behavior types and resource tags of the multimedia resources.

In one implementation, the resource attribute at least includes a resource tag.

In an implementation, the acquiring module 11 is configured to: acquire at least one of resource title information, resource introduction information, geographic position information, and author information of the multimedia resource; and extract the resource tag of the multimedia resource based on at least one of the resource title information, the resource introduction information, the geographic position information, and the author information of the multimedia resource.

In another implementation, the acquiring module 11 is configured to: acquire a resource production template and/or a resource production special effect corresponding to the multimedia resource; and extract the resource tag of the multimedia resource based on the resource production template and/or the resource production special effect corresponding to the multimedia resource.

In yet another implementation, the acquiring module 11 is configured to perform audio recognition and/or video recognition on the multimedia resource to obtain resource content of the multimedia resource; and extract the resource tag of the multimedia resource based on the resource content of the multimedia resource.

In one implementation, the selecting module 12 is configured to determine the associated application function set of the multimedia resource based on the resource attribute of the multimedia resource, and a correspondence between the resource attribute and the application function; and select the target application function from the associated application function set of the multimedia resource based on the user attribute.

In one implementation, the selecting module 12 is configured to select, among the associated application function set of the multimedia resource, application functions resource attribute of which is the same as the user attribute as candidate application functions; use the candidate application function as the target application function if one candidate application function is determined; and determine the target application function from multiple candidate application functions if multiple candidate application functions are determined.

In a possible implementation, the selecting module 12 is configured to: acquire popularity of each of the candidate application functions in a second time period; and determine the target application function from the candidate application functions based on the popularity of each of the candidate application functions in the second time period.

In one implementation, the interface area includes a user information area where the multimedia resource is presented. The displaying module 13 is configured to display the function button of the target application function in an associated display area of the user information area in the interface area.

In one implementation, the displaying module 13 is configured to: acquire a control display style corresponding to the target application function, where the control display style at least includes a display size and icon of the function button; and display the function button of the target application function according to the control display style.

In addition, some implementations of the disclosure further provide a device for displaying a multimedia resource, which can be applied to a server. FIG. 9 shows another schematic structural diagram of a device for displaying a multimedia resource provided by an implementation of the disclosure. As shown in FIG. 9, the device for displaying a multimedia resource may include a receiving module 21 and a processing module 22.

The receiving module 21 is configured to receive a target application function acquisition request sent by a terminal, where the target application function acquisition request includes user attribute and resource attribute of the multimedia resource. After the terminal acquires the user attribute of the user account and the resource attribute of the multimedia resource in response to an operation for displaying the multimedia resource being triggered through the user account, the target application function acquisition request is generated by the terminal based on the user attribute of a user account and the resource attribute of the multimedia resource. The processing module 22 is configured to select the target application function from an associated application function set of the multimedia resource in response to the target application function acquisition request, and return the target application function to the terminal, so that the terminal displays the multimedia resource and a function button of the target application function in an interface area so that the target application function is obtained by selecting and operating the function button through the user account during viewing the multimedia resource. The associated application function set includes one or more application functions associated with the multimedia resource.

In one implementation, the processing module 22 is configured to: determine the associated application function set of the multimedia resource based on the resource attribute of the multimedia resource contained in the target application function acquisition request, and a correspondence between the resource attribute and the application function; and select the target application function from the associated application function set of the multimedia resource based on the user attribute contained in the target application function acquisition request.

In one implementation, the processing module 22 is configured to: select application functions from the associated application function set of the multimedia resource, which have the same resource attribute as the user attribute contained in the target application function acquisition request, as candidate application functions; use the candidate application function as the target application function if one candidate application function is determined; and determine the target application function from multiple candidate application functions if multiple candidate application functions are determined.

In a possible implementation, the processing module 22 is configured to: acquire popularity of each of the candidate application functions in a second time period; and determine the target application function from the candidate application functions based on the popularity of each of the candidate application functions in the second time period.

As described above, some implementations of the disclosure can divide the server/terminal into function modules according to the foregoing method examples. The above-mentioned integrated modules can be implemented in a form of hardware or software function modules. In addition, it should be noted that the division of modules in some implementations of the disclosure is illustrative, and is only a logical function division, and there may be other division methods in actual implementation. For example, each function module may be divided corresponding to each function, or two or more functions may be integrated into one processing module.

Regarding the device for displaying a multimedia resource in the foregoing implementations, the specific operation modes and beneficial effects of each module have been described in detail in the foregoing method implementations, and will not be repeated here.

Some implementations of the disclosure further provide a terminal, which may be a user terminal such as a mobile phone or a computer. FIG. 10 shows a schematic structural diagram of a terminal provided by an implementation of the disclosure. As shown in FIG. 10, the terminal may include a processor 100 and a memory 200 for storing instructions executable by the processor 100. The processor 100 is configured to execute the instruction to: acquire user attribute of a user account and resource attribute of a multimedia resource in response to an operation for displaying the multimedia resource being triggered through the user account; selecting a target application function from an associated application function set of the multimedia resource based on the user attribute and the resource attribute of the multimedia resource, where the associated application function set includes one or more application functions associated with the multimedia resource; and display the multimedia resource and a function button of the target application function in an interface area so that the target application function is obtained by selecting and operating the function button through the user account during viewing the multimedia resource.

In one implementation, the processor 100 in the terminal may further be configured to implement any one or more operations of the method for displaying a multimedia resource applied to the terminal as described in the foregoing implementation when executing instructions.

Some implementations of the disclosure further provide a server, and the server may also include a processor and a memory for storing executable instructions of the processor. The difference between the server and the terminal lies is that the processor in the server is configured to execute the instructions to: receive a target application function acquisition request sent by a terminal, where the target application function request includes user attribute and resource attribute of a multimedia resource, and the target application function acquisition request is generated by the terminal according to the user attribute of a user account and the resource attribute of the multimedia resource after the terminal acquires the user attribute of the user account and the resource attribute of the multimedia resource in response to an operation for displaying the multimedia resource being triggered through the user account; select a target application function from an associated application function set of the multimedia resource according to the target application function acquisition request and return it to the terminal, so that the terminal displays the multimedia resource and a function button of the target application function in an interface area so that the target application function is obtained by selecting and operating the function button through the user account during viewing the multimedia resource, where the associated application function set includes one or more application functions associated with the multimedia resource.

In one implementation, the processor in the server may further be configured to execute any one or more operations of the method for displaying a multimedia resource applied to the server as described in the foregoing implementations when executing instructions.

In an example implementation, some implementations of the disclosure further provide a system for displaying a multimedia resource, which may include the terminal and server described above, and the terminal is communicated with the server. This system for displaying a multimedia resource can be referred to as shown in FIG. 1.

In an example implementation, the disclosure further provides a computer-readable storage medium having instructions stored thereon. The instructions, when executed by a processor, implement the method for displaying a multimedia resource applied to the terminal described in the foregoing implementations.

In an example implementation, the disclosure further provides a computer-readable storage medium having instructions stored thereon. The instructions, when executed by a processor, implement the method for displaying a multimedia resource applied to the server described in the foregoing implementations.

In one implementation, the computer-readable storage medium may be a non-transitory computer-readable storage medium, for example, the non-transitory computer-readable storage medium may be a ROM, a random access memory (RAM), or a CD-ROM, a tape, a floppy disk and an optical data storage device.

In the example implementation, the implementation of the disclosure further provides a computer program product, which when executed, implements the method for displaying a multimedia resource applied to the terminal or the server as described in the foregoing implementations.

Other implementations of the disclosure will be apparent to those skilled in the art from consideration of the specification and practice of the disclosure disclosed herein. The present application is intended to cover any variations, uses, or adaptations of the disclosure, which are in accordance with the general principles of the disclosure and include common general knowledge or conventional technical means in the art that are not disclosed in the disclosure. The specification and implementations are illustrative, and the real scope and spirit of the disclosure is defined by the appended claims.

It should be understood that the disclosure is not limited to the precise structures that have been described above and shown in the drawings, and various modifications and changes can be made without departing from the scope thereof. The scope of the disclosure is limited only by the appended claims.

What is claimed is:

1. A method for displaying a multimedia resource, comprising:
acquiring a user attribute of a user account and a resource attribute of a multimedia resource in response to an operation for displaying the multimedia resource being triggered through the user account;
selecting a target application function from an associated application function set of the multimedia resource based on the user attribute and the resource attribute of the multimedia resource, wherein the associated application function set comprises one or more application functions associated with the multimedia resource; and
displaying the multimedia resource and a function button of the target application function in an interface area so that the target application function is obtained by selecting and operating the function button through the user account during viewing the multimedia resource.

2. The method according to claim 1, wherein the user attribute comprises user interest tags, and said acquiring a user attribute of a user account comprises:
acquiring a multimedia resource set of the user account, wherein the multimedia resource set comprises one or more multimedia resources on which at least one of the following behaviors are performed through the user account within a first time period: viewing, providing comments, sharing or liking;
determining a number of multimedia resources corresponding to different resource tags in the multimedia resource set based on resource tags of individual multimedia resources in the multimedia resource set;
acquiring the number of multimedia resources corresponding to different resource tags in the multimedia resource set; and
selecting the resource tags ranked at a sorting range as the user interest tags of the user account, wherein the resource tags are sorted in a descending order based on the number of multimedia resources corresponding to the resource tags.

3. The method according to claim 2, wherein said determining a number of multimedia resources corresponding to different resource tags in the multimedia resource set based on resource tags of individual multimedia resources in the multimedia resource set comprises:
determining a number of multimedia resources corresponding to different consumption behaviors in the multimedia resources corresponding to different resource tags based on the resource tags of individual multimedia resources in the multimedia resource set and corresponding consumption behaviors, wherein the consumption behaviors comprise at least one of viewing, commenting on, sharing or giving likes to the multimedia resources; and
determining the number of multimedia resources corresponding to different resource tags based on the number of multimedia resources corresponding to different consumption behaviors in the multimedia resources corresponding to different resource tags and weight values of different consumption behaviors.

4. The method according to claim 1, wherein the user attribute comprises user interest tags; and said acquiring a user attribute of a user account comprises:
acquiring a user portrait of the user account, wherein the user portrait comprises at least one of a user age, user gender, a user geographic position, or a user multimedia resource preference type; and
obtaining an output of an interest recognition model as the user interest tags of the user account by inputting the user portrait of the user account into the interest recognition model to be processed with the interest recognition model;
wherein the interest recognition model is a model obtained by training an acquired sample set according to a neural network, and is configured to output corresponding user interest tag according to the input user portrait; the sample set comprises consumption behavior data on multimedia resources of one or more user accounts and corresponding user portrait of the one or more user accounts, and the consumption behavior data comprises consumption behavior types and resource tags of the multimedia resources.

5. The method according to claim 1, wherein the resource attribute comprises resource tags; said acquiring a resource attribute of a multimedia resource comprises:
acquiring at least one of a resource title, a resource introduction, a geographic position, or author information of the multimedia resource; and
obtaining resource tags of the multimedia resource based on at least one of the resource title, the resource introduction, the geographic position, or the author information of the multimedia resource.

6. The method according to claim 1, wherein the resource attribute comprises resource tags; said acquiring a resource attribute of a multimedia resource comprises:
acquiring a production template corresponding to the multimedia resource; obtaining resource tags of the multimedia resource based on the production template corresponding to the multimedia resource; or
acquiring a special effect corresponding to the multimedia resource; obtaining resource tags of the multimedia resource based on the special effect corresponding to the multimedia resource; or
acquiring a production template and a special effect corresponding to the multimedia resource; obtaining resource tags of the multimedia resource based on the production template and the special effect corresponding to the multimedia resource.

7. The method according to claim 1, wherein the resource attribute comprises resource tags; said acquiring a resource attribute of a multimedia resource comprises:
acquiring resource content of the multimedia resource by one of the followings: performing audio recognition on the multimedia resource; performing video recognition on the multimedia resource; or performing audio recognition and video recognition on the multimedia resource; and
obtaining resource tags of the multimedia resource based on the resource content of the multimedia resource.

8. The method according to claim 1, wherein said selecting a target application function from an associated application function set of the multimedia resource based on the user attribute and the resource attribute of the multimedia resource comprises:
determining the associated application function set of the multimedia resource based on the resource attribute of the multimedia resource, and a correspondence between the resource attribute and application functions; and
selecting the target application function from the associated application function set of the multimedia resource based on the user attribute.

9. The method according to claim 1, wherein said selecting a target application function from an associated application function set of the multimedia resource based on the user attribute and the resource attribute of the multimedia resource comprises:
sending an application function acquisition request comprising the user attribute and the resource attribute of the multimedia resource to a server, and triggering the server to select the target application function from the associated application function set of the multimedia resource and return the target application function.

10. A terminal, comprising: one or more processors and a memory for storing executable instructions of the processor; wherein the processor is configured to execute the instructions to perform the followings:
acquiring a user attribute of a user account and a resource attribute of a multimedia resource in response to an operation for displaying the multimedia resource being triggered through the user account;
selecting a target application function from an associated application function set of the multimedia resource based on the user attribute and the resource attribute of the multimedia resource, wherein the associated application function set comprises one or more application functions associated with the multimedia resource; and
displaying the multimedia resource and a function button of the target application function in an interface area so that the target application function is obtained by selecting and operating the function through the user account during viewing the multimedia resource.

11. The terminal according to claim 10, wherein the user attribute comprises user interest tags, and said acquiring a user attribute of a user account comprises:
acquiring a multimedia resource set of the user account, wherein the multimedia resource set comprises one or more multimedia resources on which at least one of the following behaviors are performed through the user account within a first time period: viewing, providing comments, sharing or liking;
determining a number of multimedia resources corresponding to different resource tags in the multimedia resource set based on resource tags of individual multimedia resources in the multimedia resource set;
acquiring the number of multimedia resources corresponding to different resource tags in the multimedia resource set; and
selecting the resource tags ranked at a sorting range as the user interest tags of the user account, wherein the resource tags are sorted in a descending order based on the number of multimedia resources corresponding to the resource tags.

12. The terminal according to claim 11, wherein said determining a number of multimedia resources corresponding to different resource tags in the multimedia resource set based on resource tags of individual multimedia resources in the multimedia resource set comprises:
determining a number of multimedia resources corresponding to different consumption behaviors in the multimedia resources corresponding to different resource tags based on the resource tags of individual multimedia resources in the multimedia resource set and corresponding consumption behaviors, wherein the consumption behaviors comprise at least one of viewing, commenting on, sharing or giving likes to the multimedia resources; and
determining the number of multimedia resources corresponding to different resource tags based on the number of multimedia resources corresponding to different consumption behaviors in the multimedia resources corresponding to different resource tags and weight values of different consumption behaviors.

13. The terminal according to claim 10, wherein the user attribute comprises user interest tags; and said acquiring a user attribute of a user account comprises:
acquiring a user portrait of the user account, wherein the user portrait comprises at least one of a user age, user gender, a user geographic position, or a user multimedia resource preference type; and
obtaining an output of an interest recognition model as the user interest tags of the user account by inputting the user portrait of the user account into the interest recognition model to be processed with the interest recognition model;
wherein the interest recognition model is a model obtained by training an acquired sample set according to a neural network, and is configured to output corresponding user interest tag according to the input user portrait; the sample set comprises consumption behavior data on multimedia resources of one or more user accounts and corresponding user portrait of the one or more user accounts, and the consumption behavior data comprises consumption behavior types and resource tags of the multimedia resources.

14. The terminal according to claim 10, wherein the resource attribute comprises resource tags; said acquiring a resource attribute of a multimedia resource comprises:
acquiring at least one of a resource title, a resource introduction, a geographic position, or author information of the multimedia resource; and
obtaining resource tags of the multimedia resource based on at least one of the resource title, the resource introduction, the geographic position, or the author information of the multimedia resource.

15. The terminal according to claim 10, wherein the resource attribute comprises resource tags; said acquiring a resource attribute of a multimedia resource comprises:
acquiring a production template corresponding to the multimedia resource; obtaining resource tags of the multimedia resource based on the production template corresponding to the multimedia resource; or
acquiring a special effect corresponding to the multimedia resource; obtaining resource tags of the multimedia resource based on the special effect corresponding to the multimedia resource; or
acquiring a production template and a special effect corresponding to the multimedia resource; obtaining resource tags of the multimedia resource based on the production template and the special effect corresponding to the multimedia resource.

16. The terminal according to claim 10, wherein the resource attribute comprises resource tags; said acquiring a resource attribute of a multimedia resource comprises:
acquiring resource content of the multimedia resource by one of the followings: performing audio recognition on the multimedia resource; performing video recognition on the multimedia resource; or performing audio recognition and video recognition on the multimedia resource; and
obtaining resource tags of the multimedia resource based on the resource content of the multimedia resource.

17. The terminal according to claim 10, wherein said selecting a target application function from an associated application function set of the multimedia resource based on the user attribute and the resource attribute of the multimedia resource comprises:
determining the associated application function set of the multimedia resource based on the resource attribute of the multimedia resource, and a correspondence between the resource attribute and application functions; and
selecting the target application function from the associated application function set of the multimedia resource based on the user attribute.

18. The terminal according to claim 10, wherein said selecting a target application function from an associated application function set of the multimedia resource based on the user attribute and the resource attribute of the multimedia resource comprises:
sending an application function acquisition request comprising the user attribute and the resource attribute of the multimedia resource to a server, and triggering the server to select the target application function from the associated application function set of the multimedia resource and return the target application function.

19. A system for displaying a multimedia resource, comprising a terminal and a server; wherein the terminal and the server are in communication connection;
wherein the terminal comprises one or more processors and a memory for storing executable instructions of the processor; wherein the processor is configured to execute the instructions to: acquire a user attribute of a user account and a resource attribute of a multimedia resource in response to an operation for displaying the multimedia resource being triggered through the user account; select a target application function from an associated application function set of the multimedia resource based on the user attribute and the resource attribute of the multimedia resource, wherein the associated application function set comprises one or more application functions associated with the multimedia resource; and display the multimedia resource and a function button of the target application function in an interface area so that the target application function is obtained by selecting and operating the function through the user account during viewing the multimedia resource;
wherein the server comprises one or more processors and a memory for storing executable instructions of the processor; wherein the processor is configured to execute the instructions to:
receive a target application function acquisition request sent by a terminal, wherein the target application function acquisition request comprises a user attribute and a resource attribute of a multimedia resource, wherein after acquiring the user attribute of a user account and the resource attribute of the multimedia resource in response to an operation for displaying the multimedia resource being triggered through the user account, the terminal generates the target application function acquisition request based on the user attribute of the user account and the resource attribute of the multimedia resource; and select a target application function from an associated application function set of the multimedia resource in response to the target application function acquisition request, and return the target application function to the terminal, so that the terminal displays the multimedia resource and a function button of the target application function in an interface area, and the target application function is obtained by selecting and operating the function button through the user account during viewing the multimedia resource, wherein the associated application function set comprises one or more application functions associated with the multimedia resource.

20. The system according to claim 19, wherein the processor of the server is further configured to:
determine the associated application function set of the multimedia resource based on the resource attribute of the multimedia resource contained in the application function acquisition request, and a correspondence between the resource attribute and application functions; and
select the target application function from the associated application function set of the multimedia resource based on the user attribute contained in the application function acquisition request.
